(19) United States
(12) Patent Application Publication
(10) Pub. No.: US 2023/0249173 A1
(43) Pub. Date: Aug. 10, 2023

(54) PLATFORM FOR ROBOTIC MICRO-EXPERIMENTATION OF SOLUTION-PROCESSED MATERIALS AND DEVICES

(71) Applicant: North Carolina State University, Raleigh, NC (US)

(72) Inventors: Aram Amassian, Raleigh, NC (US); Tonghui Wang, Raleigh, NC (US); Jacob Mauthe, Morrisville, NC (US)

(21) Appl. No.: 18/106,287

(22) Filed: Feb. 6, 2023

Related U.S. Application Data
(60) Provisional application No. 63/306,800, filed on Feb. 4, 2022.

(51) Int. Cl. B01L 3/02; B01L 3/00; B25J 9/16; G01N 1/14

(52) U.S. Cl. CPC B01L 3/0293; B01L 3/0268; B01L 13/02; B01L 3/5085; B25J 9/1669; G01N 1/14; B01J 2219/00689

(57) ABSTRACT

The present subject matter relates to systems and methods for the formulation of inks from stock solutions in which a liquid handler is configured to draw samples from a plurality of solution components and mix the components together to create one or more ink formulations, and a dispensing robot is configured to transfer the one or more ink formulations to a common substrate to form one or more material samples or a coating element in communication with the liquid handler is configured to transfer the one or more ink formulations to a common substrate to form one or more material samples. A controller in communication with each of the liquid handler and the dispensing robot can be configured to coordinate the creation and transfer of the one or more ink formulations. In addition, the one or more material samples can be analyzed using one or more characterization instrument configured to characterize the material samples on the common substrate.

### CROSS-REFERENCE TO RELATED APPLICATIONS

This application claims the benefit of, and priority to, U.S. Provisional Patent No. 63/306,800, which was filed on Feb. 4, 2023, the contents of which are incorporated by reference herein in their entirety.

### GOVERNMENT INTEREST

This invention was made with government support under grant numbers CBET1934351 and ECCS1936527 awarded by the National Science Foundation and under grant number N00014-20-1-2183 awarded by the Office of Naval Research. The government has certain rights in the invention.

### TECHNICAL FIELD

The subject matter disclosed herein relates generally to systems and methods for formulation of solution mixtures, inks, slurries, and other materials from stock solutions. More particularly, the subject matter disclosed herein relates to systems and methods for the computer-controlled formulations from stock solutions and subsequent dispensing and application of formulations on substrates using a variety of printing and coating techniques which enables on-demand formulation and printing/coating of one or more materials on one or multiple substrates.

### BACKGROUND

Solution-processed materials, including semiconductors such as metal oxides, metal halide perovskites (MHPs), conjugated organic molecules and polymers, colloidal quantum dots, and two-dimensional materials, have attracted tremendous attention over the past decade, promising to revolutionize many fields of electronics, renewable energy, biomaterials, among other applications. However, given the large compositional and chemical space of these materials, meeting multiple material requirements together with solid-state material properties and application-related device performance and operational stability, are examples of criteria that cannot be addressed using trial-and-error and heuristics approaches.

It can be informative for materials to be evaluated and tested in the solid state to ascertain their properties, performance, and stability. Present systems and methods for formulation of materials from stock solutions are slow, costly, and thus generally are only used for large-scale projects, including manufacturing. Attempts have been made to automate such systems and methods, but such systems have been able to integrate very few characterization methods, which are typically very expensive, and have not included the formulation of new material inks from stock solutions, or cleaning and flushing of existing inks from the printing and coating heads and lines to enable printing and coating of pre-formulated or newly formulated inks.

In particular, for example, existing slot die coaters and spray coaters use syringe pumps to dispense ink through a tube and a slot die head or spray nozzle. Robotic slot die heads or spray nozzles operate the same way, but are mounted on x-y-z motors enabling motion control over the slot die head or spray nozzle, similar to 3D printers. In such configurations, materials cannot be easily changed or formulated on demand with the exception of simple mixing experiments where two or more precursors or inks are mixed in a mixing chamber upstream or in the slot die head or spray nozzle. Even in such experiments, however, large volumes and mixing during flow are required, and the experiments are limited to the choice of inks and precursors being mixed. The coatings also typically cover large areas and require a serial characterization workflow which is time consuming.

Thus, it would be beneficial for new systems and methods to be developed that address these issues with the speed, cost, and availability of multiple ink preparations and the printing or coating of multitude of materials and ink formulations in an integrated manner on one or more substrate in a manner that enables use of multiple characterization methods on multiple materials but on a significantly reduced number of substrates and enables more techniques to be used in a high throughput manner using fewer operational steps and even in a parallel characterization scheme.

### SUMMARY

In accordance with this disclosure, systems, and methods for formulation of inks and other materials from feedstock are provided. In one aspect, a system for the formulation of inks from feedstock is provided. The system includes a liquid handler configured to draw samples from a plurality of solution components and mix the components together to create one or more ink formulations; a dispensing robot configured to transfer the one or more ink formulations to a common substrate to form one or more material samples; and a controller in communication with each of the liquid handler and the dispensing robot, the controller being configured to coordinate the creation and transfer of the one or more ink formulations. In some embodiments, one or more characterization instrument is configured to characterize the material samples on the common substrate.

In another aspect, a system for the formulation of inks from feedstock includes a liquid handler configured to draw samples from a plurality of solution components and mix the components together to create one or more ink formulations, a coating element in communication with the liquid handler and configured to transfer the one or more ink formulations to a common substrate to form one or more material samples, and a controller in communication with the liquid handler, the controller being configured to coordinate the creation and transfer of the one or more ink formulations.

In another aspect, a method for the deposition of materials on a common substrate is provided. The method includes operating a liquid handler to draw samples from a plurality of solution components and mix the components together to create one or more ink formulations; and transferring the one or more ink formulations to a common substrate to form one or more material samples. In some embodiments, operating the liquid handler and transferring the one or more ink formulations are coordinated by a computer controller. In some embodiments, one or more characterization instrument can be used to characterize the one or more material samples on the common substrate.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1A is a perspective side view of a system for the formulation of inks from stock solutions according to an embodiment of the presently disclosed subject matter.

FIG. 1B shows a series of steps i-vi in a method for computer-controlled formulation of inks from stock solutions according to an embodiment of the presently disclosed subject matter.

FIG. 2 is a schematic plan view of an array of component sources for the computer-controlled formulation of inks from stock solutions according to an embodiment of the presently disclosed subject matter.

FIG. 3 is a perspective side view of a system for the formulation of inks from stock solutions utilizing slot die coating according to an embodiment of the presently disclosed subject matter.

FIG. 4 is a side perspective view of a slot die coating system according to an embodiment of the presently disclosed subject matter.

FIG. 5 is a flow chart illustrating steps in a method for computer-controlled formulation of inks from stock solutions according to an embodiment of the presently disclosed subject matter.

FIG. 6 is a perspective side view of a system for the formulation of inks from stock solutions according to an embodiment of the presently disclosed subject matter.

FIG. 7A is an image of an array of ink formulations on a substrate according to an embodiment of the presently disclosed subject matter.

FIG. 7B is a series of graphs showing material characterization results of an array of ink formulations according to an embodiment of the presently disclosed subject matter.

FIG. 8 is a graph illustrating absorbance and normalized PL intensity of a sample according to an embodiment of the presently disclosed subject matter.

FIG. 9 illustrates a configuration of a transmission wide angle x-ray scattering test, a representative image, and a graph of corresponding intensities according to an embodiment of the presently disclosed subject matter.

FIG. 10 is a plan view of composition space mapping on a common substrate according to an embodiment of the presently disclosed subject matter.

FIG. 11 shows a series of flow charts comparing a conventional manual workflow, an automated serial workflow, and a method for the formulation of inks from stock solutions according to an embodiment of the presently disclosed subject matter.

FIGS. 12 and 13 are graphs illustrating differences in time and cost of a conventional manual workflow, an automated serial workflow, and a method for the formulation of inks from stock solutions according to an embodiment of the presently disclosed subject matter.

FIG. 14 is a series of diagrams that illustrate an example of micro-experimentation on a substrate using mixed ion metal halide perovskites according to an embodiment of the presently disclosed subject matter.

FIG. 15 is a series of diagrams that illustrate an example showing a numerical model of bandgap of quaternary metal halide perovskite compound being used to derive 14 distinct compositions according to an embodiment of the presently disclosed subject matter.

FIG. 16 is a series of diagrams that illustrate a layered perovskite with varying composition and quantum well size according to an embodiment of the presently disclosed subject matter.

FIG. 17 is a series of diagrams that illustrate single crystals of metal halide perovskites printed on substrates with surface treatment and by formulating inks together with co-solvents according to an embodiment of the presently disclosed subject matter.

FIG. 18 is a series of images that show stock solutions made of nanoparticles, including colloidal quantum dots according to an embodiment of the presently disclosed subject matter.

FIG. 19 is a series of images that show micro-printing of quantum dot samples directly on a SiN membrane according to an embodiment of the presently disclosed subject matter.

FIG. 20 is a series of images that show PEDOT:PSS conducting polymer formulation, printing, and electrical characterization according to an embodiment of the presently disclosed subject matter.

FIG. 21 is a series of images that show a demonstration of Si substrates pre-patterned with electrodes enabling electrical characterization and fabrication of devices according to an embodiment of the presently disclosed subject matter.

FIG. 22 is a series of diagrams that illustrate semiconducting polymer formulation and printing on glass substrates for a photodegradation study according to an embodiment of the presently disclosed subject matter.

### DETAILED DESCRIPTION

The presently disclosed subject matter provides in some embodiments systems and methods for the computer-controlled formulation of inks from feedstock and subsequent dispensing and application of inks on substrates to create dot, line, and other geometric arrays on substrates using a variety of micro-printing and micro-coating techniques to fabricate large numbers of solid state materials, multilayer stacks, and devices on common substrates. In some embodiments, the feedstock includes prepared stock solutions, although those having ordinary skill in the art will recognize that other precursor materials can be derived from pelletized or powdered components that can be mixed with solvents to create a desired solution. Ink formulations can include solution mixtures, inks, slurries, and other materials, including other materials from stock solutions.

In some embodiments, the presently disclosed subject matter provides a multi-robot instrument which can formulate functional material inks on demand and print multiple materials on substrates with high spatial resolution and small volumes, thus making it possible to integrate a plurality of diverse materials or ways of formulating the same material onto the same substrate. In some embodiments, the materials on the substrate can be characterized using a variety of optical, structural, electrical, and other methods, thus providing considerable data in a short period of time and with considerable cost savings and material waste reduction.

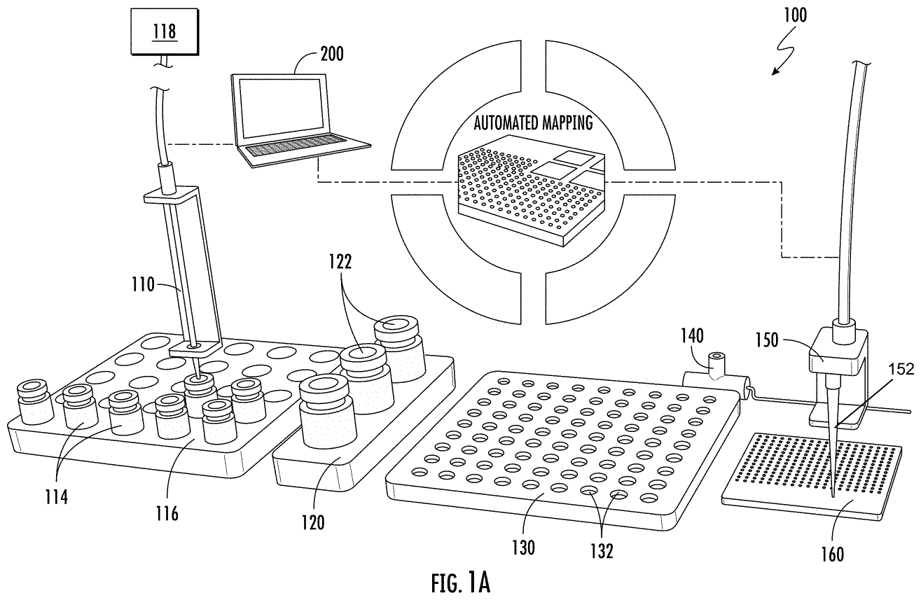

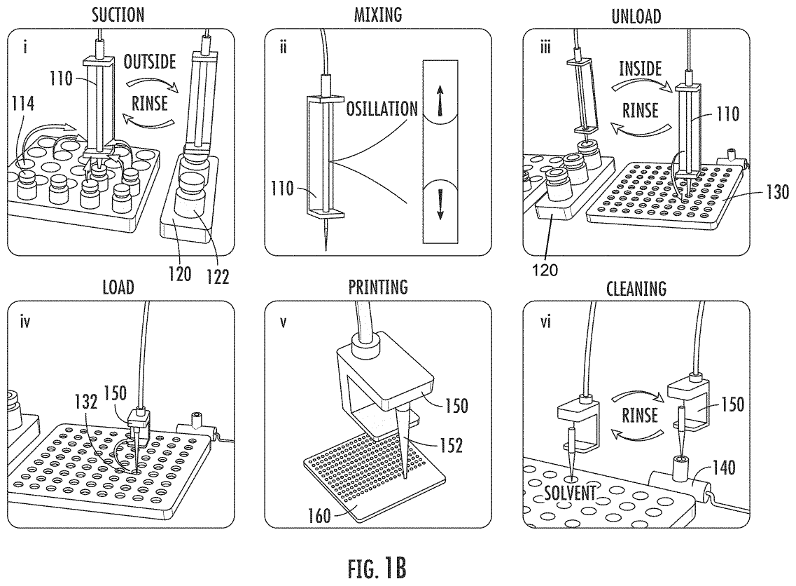

Referring to an arrangement shown in FIGS. 1A and 1B, inks can be formulated from stock solutions using a platform, generally designated 100, that includes a liquid handler 110 that is controllable to draw selected amounts of components (e.g., samples, e.g., volumes of solution components) and mix the components together. The selected amounts of components can be chosen based on the desired material to be prepared. For example, a suitable or prescribed stoichiometric volume can be drawn based on the material to be prepared. In some embodiments, the liquid handler 110 is connected to a reversible pump 118 that is configured to selectively draw material into the liquid handler 110 and/or expel material out of the liquid handler 110. In some embodiments, the liquid handler 110 is further movable to be aligned with one or more components sources 114 that are arranged in an array in a precursor station 116. The liquid handler 110 can then be operated to draw selected amounts of components (e.g., samples, e.g., volumes of solution components in a prescribed or suitable stoichiometric volume) from the component sources 114.

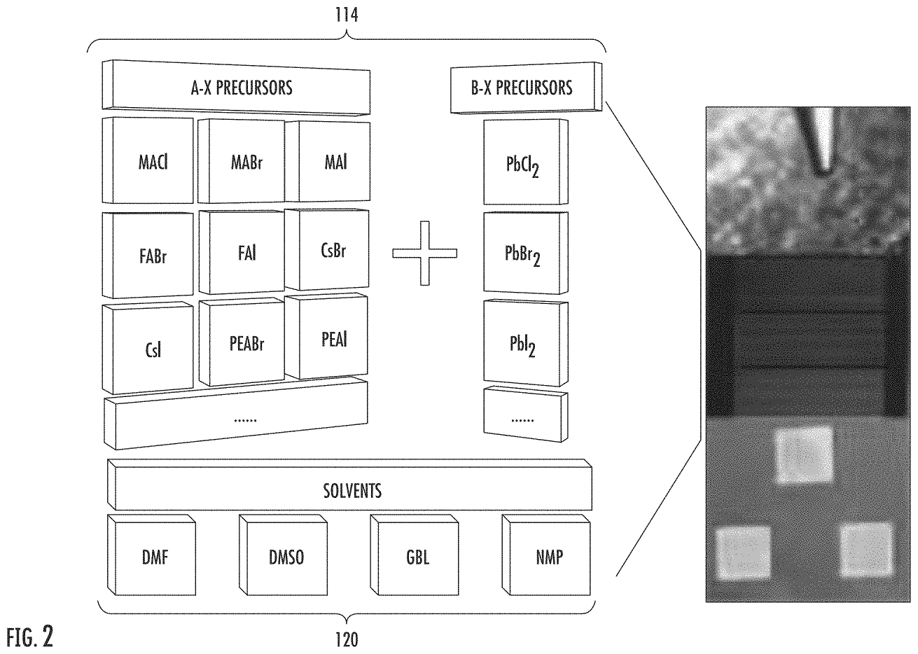

As discussed above, in some embodiments, the component sources 114 can include prepared stock solutions. As shown in FIG. 2, the precursor station 116 can include any of a variety of precursors and/or solvents in the one or more components sources 114, which can be selectively drawn into the liquid handler 110 and mixed to produce a wide range of component combinations. Component combinations can comprise two, three, four, or more components. Indeed, any suitable number of components as would be apparent to one of ordinary skill in the art up on a review of the instant disclosure can be combined into a given formulation. In the example shown in FIG. 2, the upper dot array shows a MAPbBr₃ solution being printed; the center line array represents 30 lines of FAPbBr₃, MAPbBr₃, and CsPbBr₃; and the lower square patches correspond to MAPbBr₃. Alternatively, in some embodiments, the component sources 114 can include solid feedstock (e.g., powdered or pelletized materials), and the liquid handler 110 can be configured to combine these forms of feedstock with one or more solvents to create a desired formulation.

Operation of the liquid handler 110 can include using rinsing steps to minimize cross-contamination. As shown in FIG. 1B, in some embodiments, a first wash station 120 can be provided near the precursor station 116 such that the liquid handler 110 can quickly load each component with an outside rinse after every addition. See, e.g., FIG. 1B, step (i). The first wash station 120 can include one or more solvent volumes 122 that each contain a solvent selected to rinse components from the liquid handler 110.

Once the desired combination of solution components is loaded in the liquid handler 110, the combination can be mixed together within the liquid handler 110. In some embodiments, this mixing can be achieved by operating the pump 118 associated with the liquid handler 110 in suction and extrusion directions alternatingly in an oscillating manner to combine the solution components contained therein. See, e.g., FIG. 1B, step (ii).

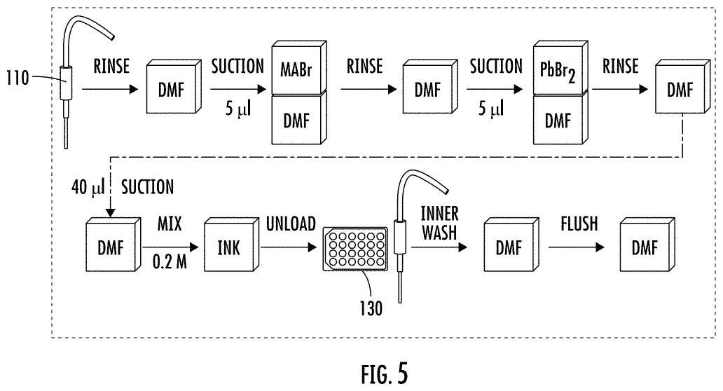

With the desired combination of solution components combined in this way, the liquid handler 110 can be configured to dispense the solution to a solution carrier 130. In some embodiments, for example, the solutions can be received in an array of sample wells 132 that are formed in the solution carrier 130, such as is shown in FIG. 1A. Alternatively, in some embodiments, the solutions can be received in one or more sample vials positioned on the solution carrier 130. e.g., Any leftover ink can be disposed of (e.g., dispensed in a vial), and the liquid handler 110 can be flushed and rinsed before the next ink is prepared and coated. See, e.g., FIG. 1B, step (iii). In some embodiments, a second wash station 140 can be provided near the solution carrier 130 such that the liquid handler 110 can quickly unload each component and be cleaned after every deposit. In some embodiments, the second wash station 140 can include a vacuum port configured to draw any remaining solution from within the liquid handler 110. An example process for loading, mixing, unloading, and cleaning the liquid handler is shown in FIG. 5 for the formulation of MAPbBr₃ starting from MABr and PbBr₂ precursor salts in stock solutions.

The platform 100 can further include a dispensing robot 150 that can be controlled to transfer the material deposited in the solution carrier 130 to a substrate 160 on which the samples can be processed and characterized. See, e.g., FIG. 1B, steps (iv)-(v). In some embodiments, for example, the dispensing robot 150 includes a hollow capillary 152 configured to collect inks from the array of sample wells 132 by dipping the tip of the capillary 152 in a selected one of the sample wells 132 and dispensing from the same tip on the substrate 160 with controlled volume. In some embodiments, the capillary 152 is connected to a miniature fluid pump (e.g., a piezoelectric fluid pump) that is operable to draw fluid into the capillary 152 or dispense fluid from the capillary 152. In addition, in some embodiments, a vacuum cleaning protocol is used to clean the capillary 152, such as by using the second wash station 140. See, e.g., FIG. 1B, step (vi). In this way, ink can be collected, printed, flushed, and washed so that the same capillary 152 can be used again.

Alternatively, in some embodiments, the liquid handler 110 can be in communication with or can itself include a coating element such as a slot die head 112 that has a narrow opening or “slot” through which the liquid can be drawn and later extruded to form a substantially uniform film. In this regard, the reversible pump 118 can be operated to selectively draw material into the slot die head 112 and/or expel material out of the slot die head 112 onto the substrate 160 directly. In some embodiments, each step in the operation of the liquid handler 110 is performed while the slot die head 112 is mounted on the liquid handler 110. In this configuration, the ink is drawn through the slot die head 112 and extruded through the slot die head 112, which allows inks to be prepared in small amounts and for the liquid handler 110 to prepare, mix, and coat inks on the fly without having to remove, disassemble, and wash the slot die head 112. In some embodiments, a second wash station 140 can be provided near the slot die head 112 such that the slot die head 112 can quickly unload each component and be cleaned after every deposit. Alternatively, in some other embodiments, the liquid handler 110 is configured to pick up the slot die head 112 and replace the slot die head 112 between ink preparation and rinsing steps. Although discussion of these embodiments refers to a slot die head, those having ordinary skill in the art will recognize that the platform 100 can be adapted to use any of a variety of printing or coating accessories, making it possible to print or coat materials that are directly formulated using scalable manufacturing processes, such as slot die coating, ink-jet printing, spray coating, spin coating, dip coating, screen printing, or any of a variety of other known coating modalities. In any configuration, the platform 100 enables direct prototyping of materials and ink formulations in manufacturing-compatible conditions.

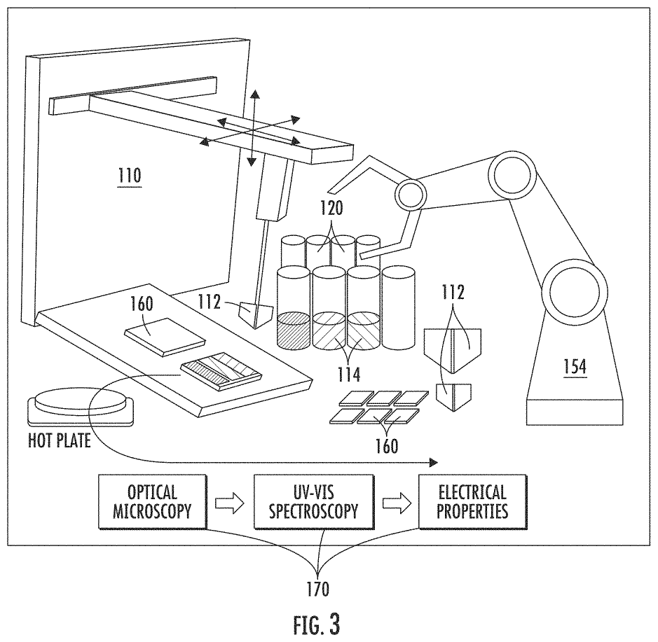

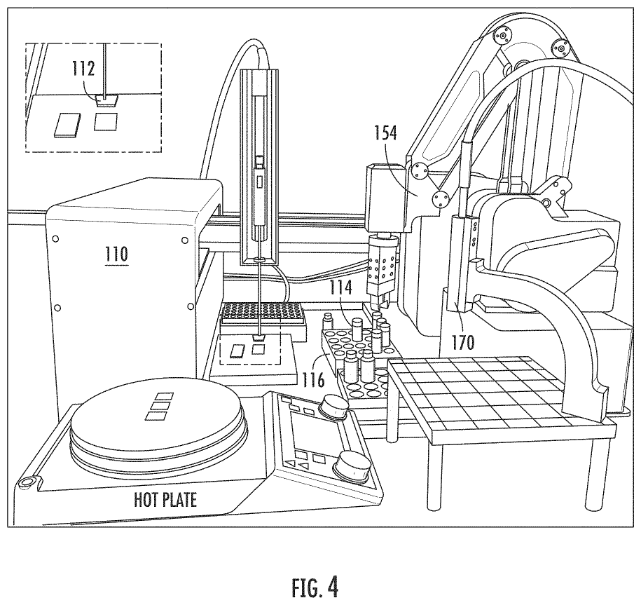

In some embodiments, where the solution carrier 130 is configured to support sample vials thereon, the dispensing robot 150 can include a robotic arm 154 configured to handle and transport the sample vials and/or the substrate 160 for ink preparation and sample flow to hot plates and existing characterization tools, such as is shown in FIGS. 3 and 4.

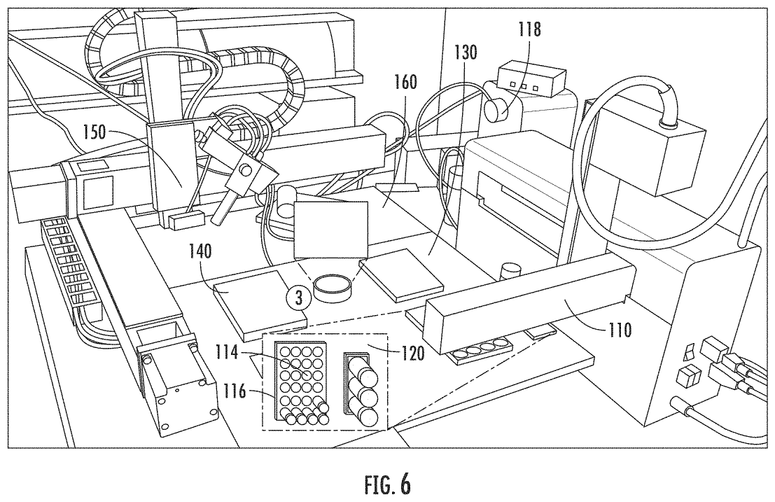

In any configuration, as shown in FIGS. 4 and 6, for example, the liquid handler 110, the precursor station 116, the first wash station 120, the solution carrier 130, the second wash station 140, and the dispensing robot 150 can all be arranged together to prepare large numbers of solid state materials on the substrate 160.

Substrate 160 can comprise any desired substrate composition and/or configuration (e.g., conducting vs insulating, optically transparent vs opaque, x-ray transparent, etc.). Any desired substrate chemistry can be employed, such as but not limited to substrate material choice, surface treatments applied through cleaning and surface treatment protocols, self-assembled monolayers, as well as coatings of various kinds. Surface chemistry can be designed to be continuously different, a gradient across the surface or to follow a geometric pattern. characterization instruments 170 that are configured to provide figures of merit and enable exploration as well as exploitation with the help of machine learning and decision algorithms, as well as closed-loop optimization, material design and material-to-device codesign. In some embodiments, for example, samples can be subject to a wide variety of characterizations, including optical microscopies and spectroscopies, x-ray diffraction, electrical characterization, and the like. The characterization instruments 170 can be integrated with the platform 100, or existing characterization instruments 170 can be used to analyze material samples produced by the platform 100. In either form, the platform 100 allows for the “palletization” of material samples for rapid sequential analysis.

In some embodiments, the platform 100 is controllable to define the boundaries of the experimentation campaigns in terms of materials composition and ink formulation, the layout of these compounds on the substrate 160, and their size and geometric patterns (dots, lines, patches, etc.) and spacings. In some embodiments, the platform further allows multiple copies of an arrangement of material samples on a substrate 160 to be created at once, for instance, to evaluate the influence of substrate chemistry, composition, and/or configuration to conduct different post-treatment conditions, such as thermal annealing, or to perform additional destructive testing, such as light degradation studies. Multiple substrates 160 can also be used to obtain reliability, reproducibility, and statistical averages, and to accelerate data acquisition when using multiple characterization platforms at once. This includes characterizations performed on-site as well as samples shared off-site for characterization at major national facilities, such as at synchrotrons. A key design consideration of multi-modal characterization campaigns on material samples is the necessity to meet the requirements of every intended characterization method. This includes measurement footprint and spatial resolution, as well as choice of substrate composition and configuration (e.g., conducting vs insulating, optically transparent vs opaque, x-ray transparent, etc.).

Alternatively or in addition, the substrate 160 on which the selected materials are deposited can be delivered to a characterization instrument 170 that is separate from the platform 100. Material samples can be characterized with any traditional tool and would only require simple translation capabilities to scan or map the compositions on the substrate 160 to turn almost any technique into a high-throughput characterization tool that saves time, cost, and considerable energy and environmental impact. The ability of the platform 100 to fabricate large numbers of solid state materials, multilayer stacks, and devices on common substrates still provides significant advantages in such a configuration since the characterization instrument 170 need only be aligned and calibrated with respect to the common substrate 160 once to enable the characterization of every sample deposited thereon. In this way, material samples can thus be portable and shareable for further off-site characterization using specialized equipment.

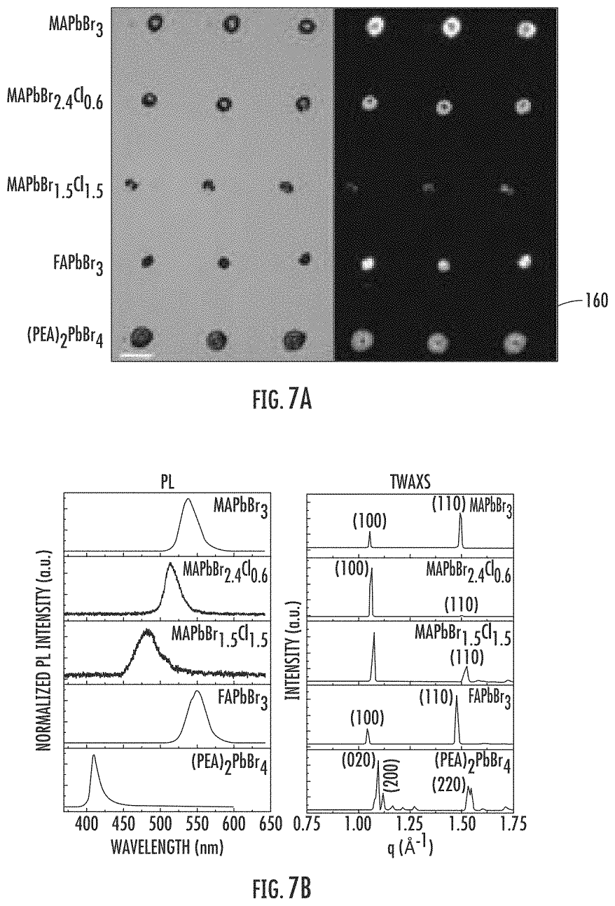

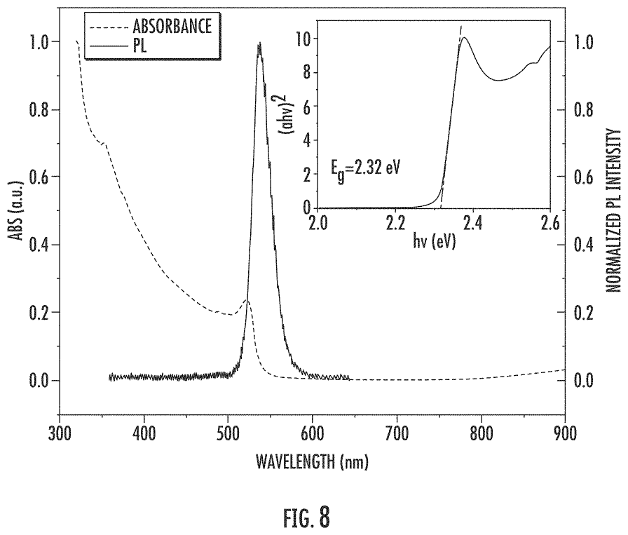

In either arrangement, characterization instruments 170 with sample mapping capabilities, spectromicroscopy, or functioning on the basis of local probing and scanning capability are particularly well suited to analyze a plurality of samples on a common substrate 160. In particular, the characterization instruments 170 can be configured to characterize the structure, optical properties, and/or photostability of the material samples directly on the substrates 160 upon which they have been collectively deposited. In some embodiments, computer controlled scripts in these instruments allow scanning of the substrate 160 and assigning the data to each material sample on the substrate 160, allowing the data to be assigned to the unique materials. In some embodiments, for example, mapping and scanning of different materials using each characterization method creates data for each pixel that can be mapped onto the unique material and ink formation of that particular pixel. As shown in FIGS. 7A and 7B, for example, an array of different solutions can be deposited on a substrate 160 (See, e.g., FIG. 7A), and one or more characterization instrument 170 can be used to analyze the multiple samples (See, e.g., FIG. 7B). In the illustrated example, optical and fluorescence images (10× magnification) of the full substrate with five metal halide perovskite (MHP) compounds and three duplicates of each printed. The scale bar is 100 μm and sample to sample distance is 200 μm. FIG. 7B provides high throughput wide angle x-ray scattering patterns (HT-WAXS) and photoluminescence (PL) spectra of the pixelated samples of FIG. 7A, confirming the structure and optical properties of the pixels correspond to the compounds.

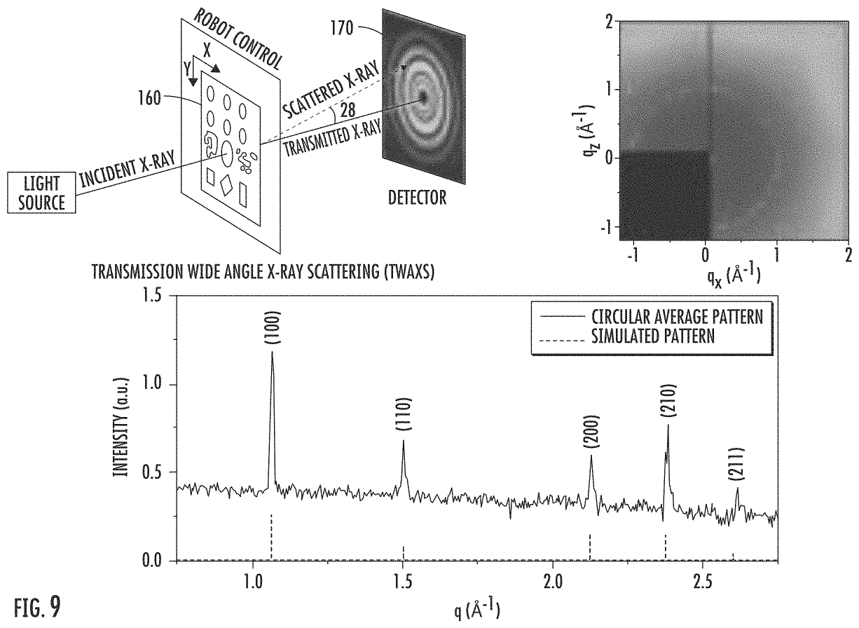

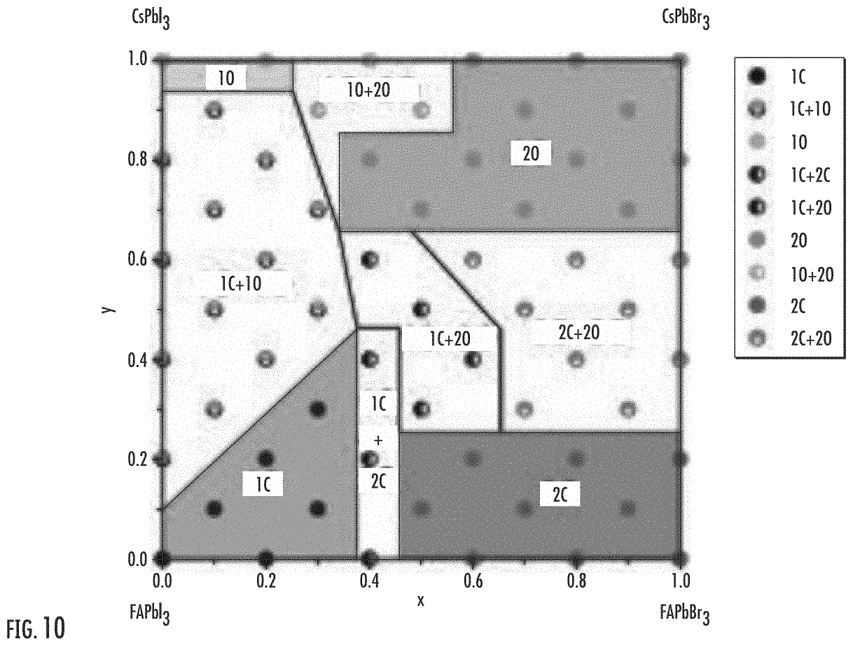

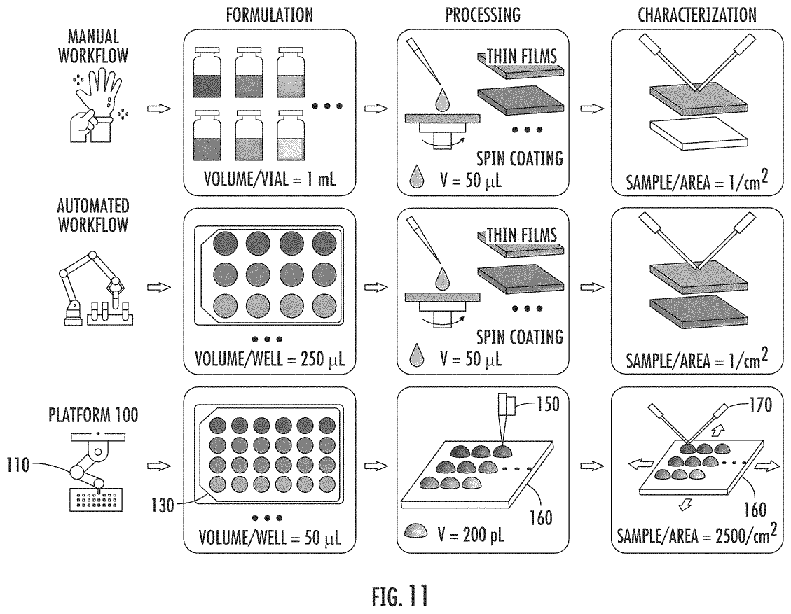

FIGS. 8, 9, and 10 illustrate further analyses of samples using a variety of characterization techniques. FIG. 8 shows the UV-Vis absorption and photoluminescence spectra of a methylammonium lead bromide (MAPbBr₃) sample fabricated by the platfrom 100. The inset figure shows the Tauc plot for the determination of the bandgap of MAPbBr₃ from the intercept of the linear region of the absorption onset with the x axis. FIG. 9 shows a circular average of the transmission p wide angle X-ray scattering pattern measured from MAPbBr₃ dots printed by the platfrom 100 compared with the simulated diffraction pattern. The inset shows the 2D image of the transmission p wide angle X-ray scattering pattern. FIG. 10 shows a quaternary phase diagram of a cesium formamidinium-based perovskite system (FA_{1-y}Cs_{y}Pb(I₁₋ₓBrₓ)₃) constructed from HT-WAXS measurements of 61 compositions. The substrate with all compounds was annealed at 150° C. for 10 mins and allowed to cool. HT-WAXS mapping was performed at room temperature in vacuum.

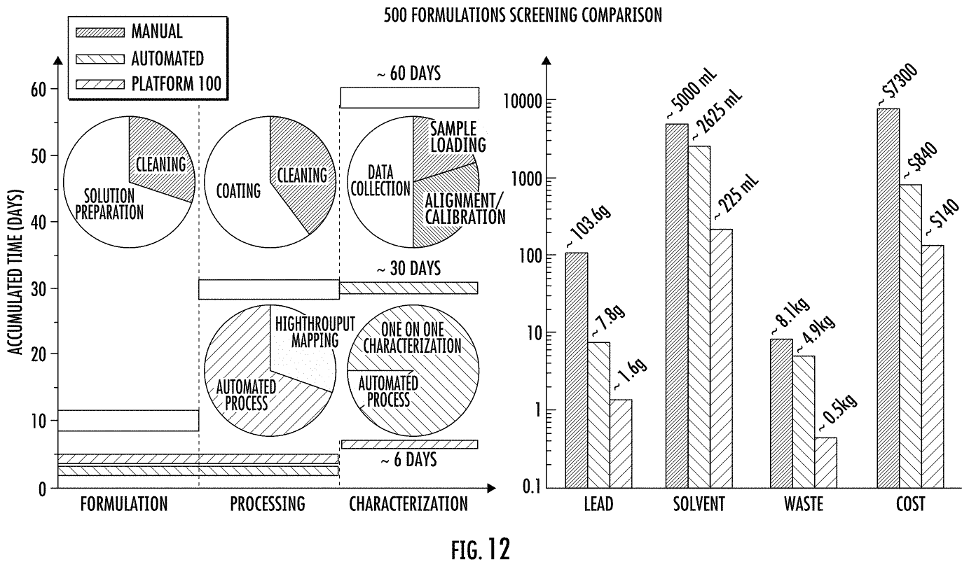

Regardless of the particular configuration, as discussed above, the platform 100 can be configured as a compact robotic laboratory which integrates materials on a chip. In this regard, the platform 100 can provide an end-to-end miniaturized, automated workflow from ink formulation to high-throughput multi-modal characterization for efficient data collection. As shown in FIGS. 11-13, compared with traditional manual workflows and existing full-scale serial automation, the present systems can be configured to be 5-10 times faster and reduces the material cost, toxic waste, and greenhouse gas emissions by more than an order of magnitude. Referring to FIG. 11, in some embodiments, either or both of the liquid handler 110 or the dispensing robot 150 are configured to use micro-printing using picoliter- to nanoliter-scale dispensing equipment to integrate dozens to hundreds of individual materials or ink formulations per substrate in a variety of shapes (e.g., dot arrays, lines, patches, or other patterns as shown in FIGS. 2 and 7A). In this way, the present systems and methods can provide versatile dispensing over a wide range of viscosities and surface tensions such that a wide range of formulations can be dispensed.

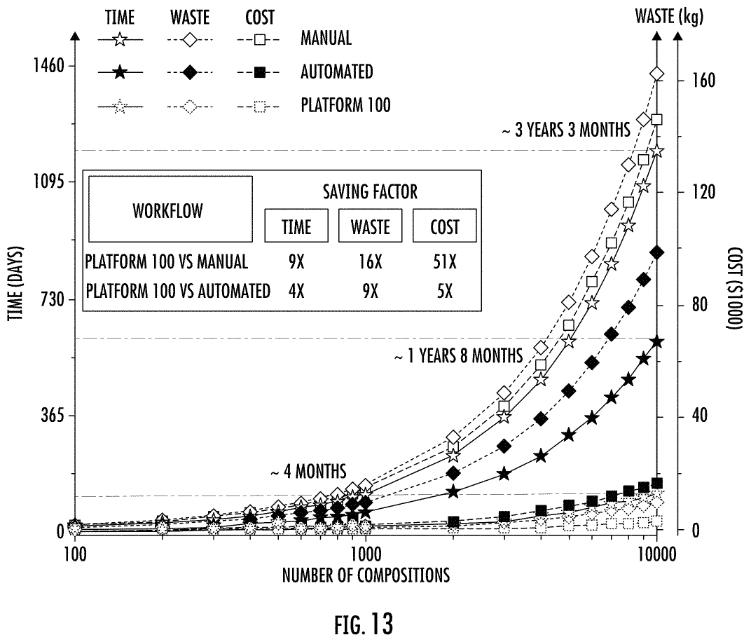

In some embodiments, for example, the liquid handler 110 can be configured to load sample wells having sizes of 504 per well or smaller, and the dispensing robot 150 can be configured to transfer volumes of 1 nL or smaller to the substrate (e.g., between about 0.5 nL and about 0.6 pL). In some embodiments, the dispensing robot 150 can be configured to transfer volumes of about 200 pL or less. In some embodiments, the dispensing robot 150 can further be configured to deposit material samples on the substrate 160 at a spatial resolution of approximately 10 μm or smaller, thereby dispensing as many as 2500 or more samples per cm³ for characterization, such as with an average size per pixel of 50 μm along a square lattice arrangement and a center-to-center spacing of 200 μm. In addition, the ability to micro-print and micro-coat multiple materials per substrate further enables micro-experimentation, which allows users of the platform 100 to extend any existing characterization platform with mechanized spatial mapping capability, including but not limited to the characterization instruments discussed above, into a high throughput characterization platform. As illustrated in FIG. 12, the graph on the left provides a comparison is provided of the accumulated time to screen (i.e., formulate, process and characterize) 500 individual formulations by the three workflows. The inset pie charts represent the fraction of time allocated to the most time-consuming steps in each workflow. The graph on the right of FIG. 12 shows the total time, waste, cost and energy demand required for all three workflows to screen 500 perovskite formulations (excluding labor and capital costs). FIG. 13 illustrates a scaling of time, energy demand, and costs with the increasing number of experiments for the three workflow scenarios. The inset table shows the relative saving ratio in terms of time, energy demand, and cost when comparing the platform 100 with manual and automated workflows. This data shows that the present systems and methods provide significant savings in time and cost compared to existing systems and methods.

Furthermore, in some embodiments, software is used to operate the liquid handler 110 and the dispensing robot 150. In some embodiments, a controller 200 is in communication with one or more of the liquid handler 110, the dispensing robot 150, and the one or more characterization instrument 170, the controller 200 being configured to coordinate the transfer and analysis of the plurality of material samples. In embodiments in which the ink formulation and material design is computer-controlled, material preparation instructions can be digitized and linked to the sample generated and the location of the materials on the substrate digitally. In some embodiments, the platform 100 automatically digitizes all material, ink, and sample preparation protocols and facilitates digitization of the data collection, implementation of data science, and machine learning/artificial intelligence. In this way, materials from different characterization methods can be mapped back to the composition, ink formulation, and processing to derive quantitative relationships and models that can be used to predict material properties as well as help design new materials and processing routes.

In addition, all characterization data obtained from the materials on substrates can be collected and assigned to uniquely identified samples and help construct a database, either locally or on the cloud, to enable data analytics and visualization. In some embodiments, the system can be used to perform closed-loop optimization whereby characterization results are used to guide future experiments manually, automatically, semi-autonomously, or autonomously with the help of statistical, machine-learning, and artificial intelligence algorithms.

In some embodiments, for example, the presently disclosed systems and methods can be used to facilitate any of a variety of post-process data analysis functions, including but not limited to uncertainty quantification, feature extraction, intelligent exploration of parameter space, exploitation and multi-parameter optimization, closed-loop experimentation with decision making under uncertainty, and semi-autonomous and autonomous experimentation. The availability of coating attachments, such as slot die coaters allows the robotic formulation and coating of materials, multilayers, and devices in a manner that resembles manufacturing of coatings and devices by solution processing. This enables research and development of materials, inks, and devices to be performed using the same rapid prototyping platform and to produce prototypes that resemble manufactured products in similar tooling conditions.

The presently disclosed systems and methods can be configured to formulate and print a wide range of materials, including semiconducting and conducting polymers, conjugated molecules and polymers (including conjugated organic molecules and polymers), metal halide perovskites (MHPs), hybrid metal halides, colloidal quantum dots, metal nanoparticle inks, semiconductors such as metal oxides, and two-dimensional materials. In some embodiments, the plurality of solution components comprises materials selected from the group consisting of semiconducting materials, semiconducting polymers, conducting polymers, insulating polymers, conjugated molecules and components thereof (including conjugated molecules and polymers and components thereof, including conjugated organic molecules and polymers and components thereof), metal halide perovskite components, hybrid metal halide components, nanoparticles, and colloidal quantum dot components. In some embodiments, for example, the fluid-handling capabilities of the liquid handler 110 and front loading and dispensing of the capillary printing and slot die coating designs enable handling of a wide range of liquids and solutions, washing and rising of parts, and the ability to work over a wide range of viscosities and surface energies. In addition, the ability to formulate materials ranging from conductors to semiconductors and insulators allows layering of these materials to fabricate functional multi-layer structures and devices for electronic, optoelectronic, photovoltaic, and other applications. Further in this regard, in some embodiments, the substrate 160 can be prepatterned with electrodes to perform electrical characterizations as well as to fabricate electronic and optoelectronic devices. In addition, in some embodiments, duplicate ink formulations can be fabricated on each substrate 160, and multiple such substrates can be measured in different facilities within the same institution or elsewhere, allowing considerable data collection.

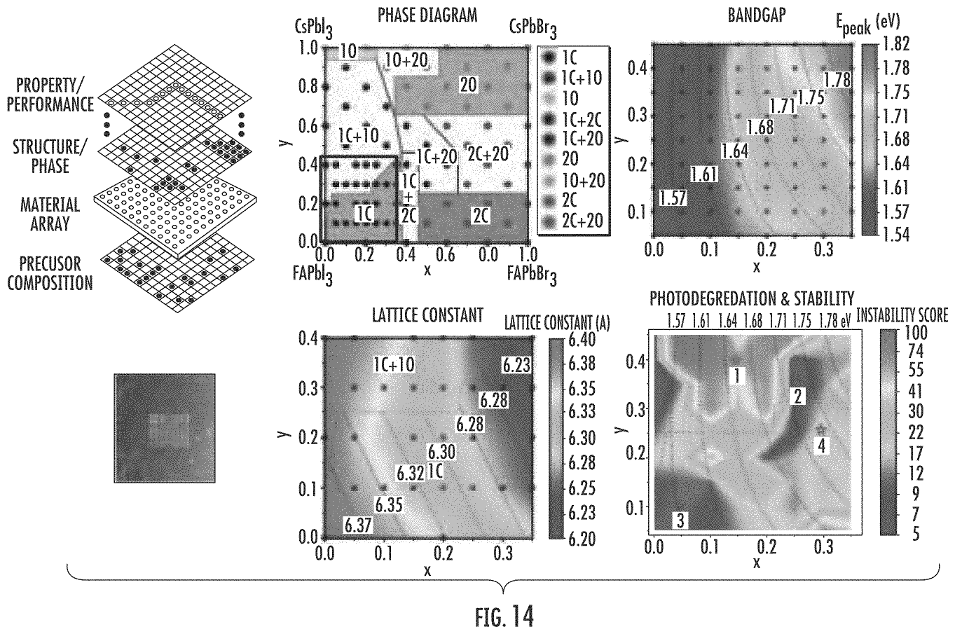

Referring to FIGS. 14-22, the presently disclosed systems and methods can be used with conducting polymer printing and electrical testing, organic semiconductor printing and testing, organic PV materials printing and degradation testing, and layered perovskites printing and x-ray analysis. Referring to FIG. 14, for example, micro-characterization using x-ray diffraction and photoluminescence enable the establishment of an in-house database as well as quantitative and numerical relationships linking composition to structure, structure to property, and structure to certain performance figures of merit. These can be used to build predictive numerical models for such material systems.

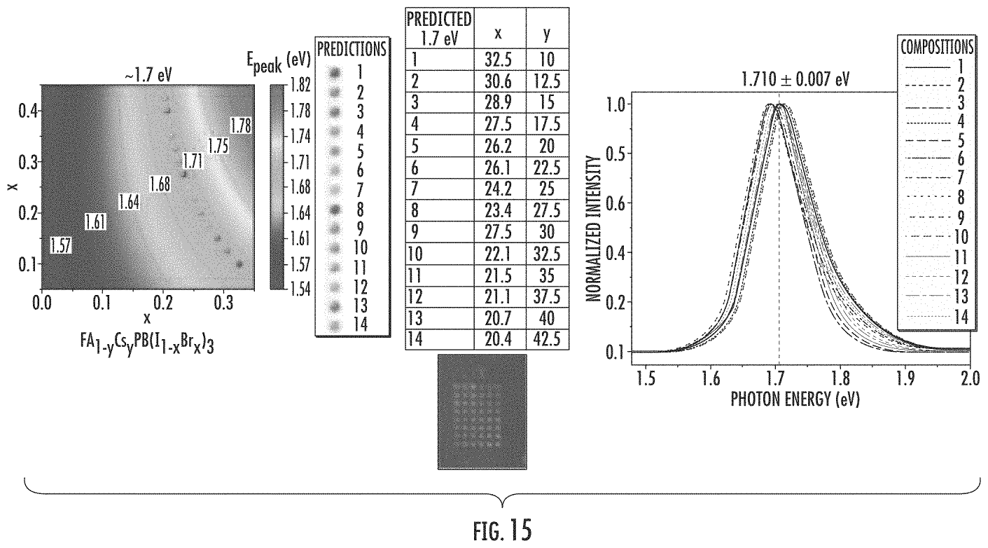

FIG. 15 illustrates an example showing a numerical model of bandgap of quaternary metal halide perovskite compound (FA_{1-y}Cs_{y}Pb(I₁₋ₓBrₓ)₃) being used to derive 14 distinct compositions in terms of x and y that are numerically predicted to achieve the same bandgap of 1.7 eV. The platform 100 formulates the associated inks and prints these on the substrates. Subsequent micro-PL characterization demonstrates all newly synthesized compositions to yield a bandgap of 1.71+−0.007 eV, in agreement with numerical prediction.

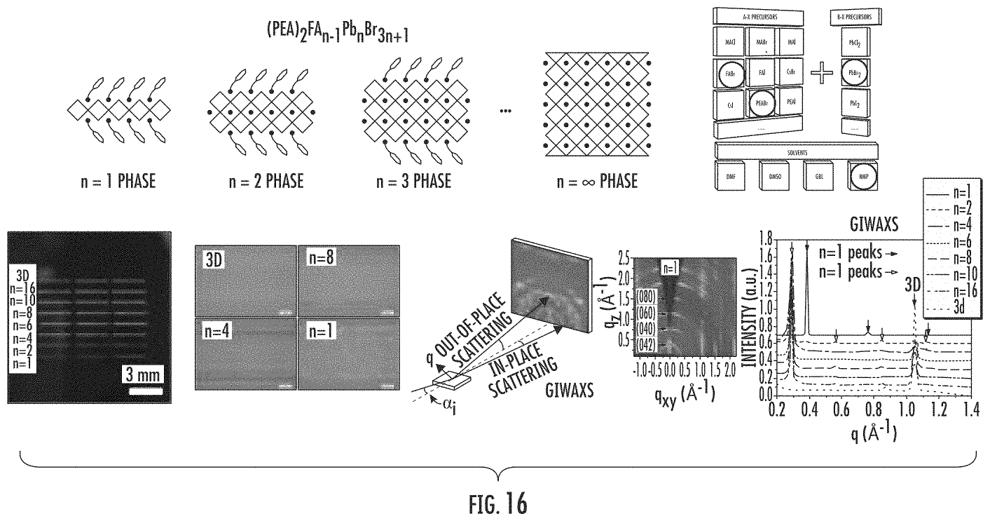

FIG. 16 illustrates a Ruddlesden-Popper layered perovskite ((PEA)₂FAₙ₋₁PbₙBr₃ₙ₊₁) with varying composition and quantum well size that is formulated using n value and printed in lines on the substrate to enable grazing incidence wide angle x-ray scattering (GIWAXS) characterization of structure and crystallographic texture of the quantum wells and various phases.

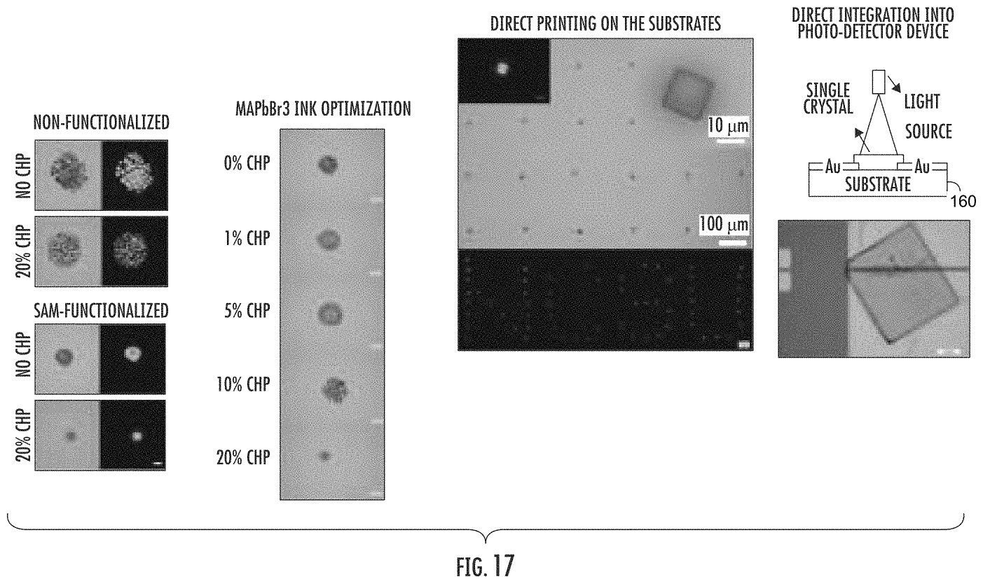

FIG. 17 illustrates single crystals of metal halide perovskites (MAPbBr₃) printed on substrates with surface treatment and by formulating inks together with co-solvents (e.g., N-cyclohexyl-2-pyrrolidone (CHP)) to optimize the evaporation rate, coffee ring formation, solubility vs time, and supersaturation. This allows optimally formulated inks to print single crystal arrays on the substrate. In case of pre-patterned substrates, the crystals can be grown on electrodes to enable electronic and optoelectronic device fabrication and testing.

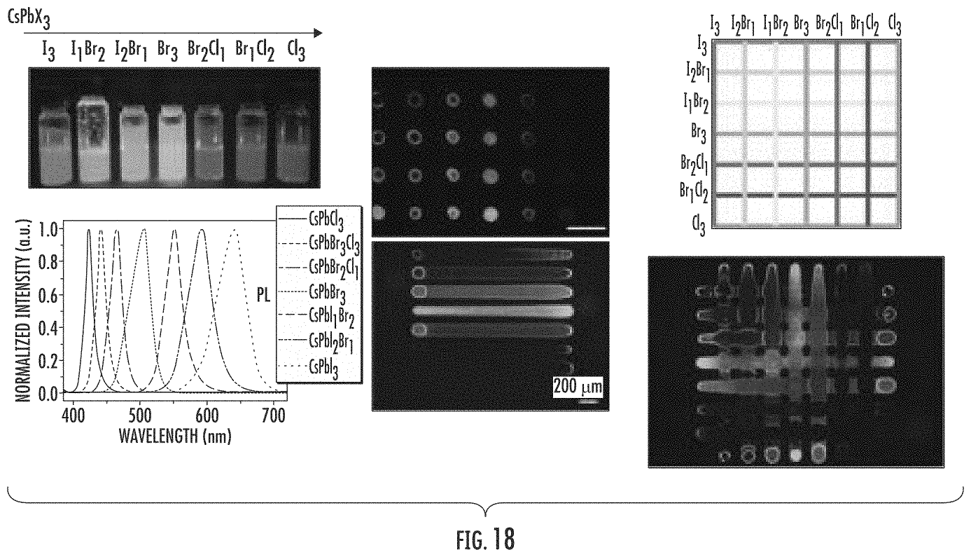

FIG. 18 shows stock solutions made of nanoparticles, including colloidal quantum dots. In this example, cesium lead halide perovskite (CsPbX₃, where X represents a halogen) quantum dots are printed as dot arrays or lines on a substrate for further characterization. On the example on the right, a cross hatch pattern of these quantum dots is printed enabling mixed regions of quantum dots to be formed where solid-state reactions, such as halide exchange, can be investigated using micro-experimentation methods.

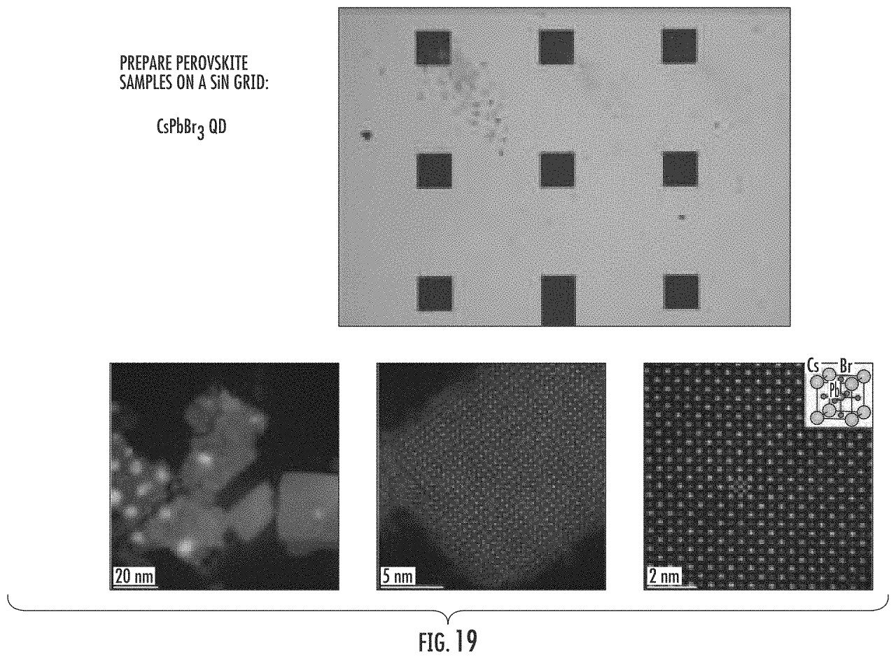

FIG. 19 shows micro-printing of quantum dot samples directly on a SiN membrane compatible with transmission electron microscopy (TEM) according to an embodiment of the presently disclosed subject matter to demonstrate TEM micro-experimentation of CsPbBr₃ quantum dots (QDs) printed on a TEM grid. This in effect demonstrates the ability to automatically formulate and transfer materials on a TEM grid and perform atomic resolution imaging and characterization.

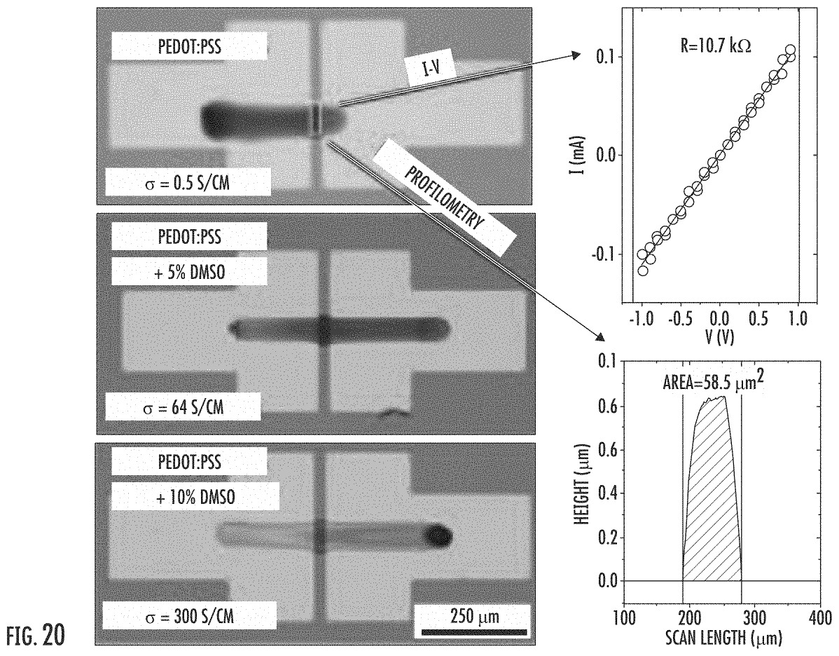

FIG. 20 is a series of images that show poly(3,4-ethylenedioxythiophene) polystyrene sulfonate (PEDOT:PSS) conducting polymer formulation, printing, and electrical characterization according to an embodiment of the presently disclosed subject matter. In this example, PEDOT:PSS conducting polymer in aqueous suspension is mixed with DMSO solvent and printed on a substrate pre-patterned with metal electrodes. A probe station equipped with automated I-V measurements measures the resistance of each polymer print. A profilometer then maps the entire substrate and provides the cross section of each individual PEDOT:PSS print to allow accurate extraction of conductivity values.

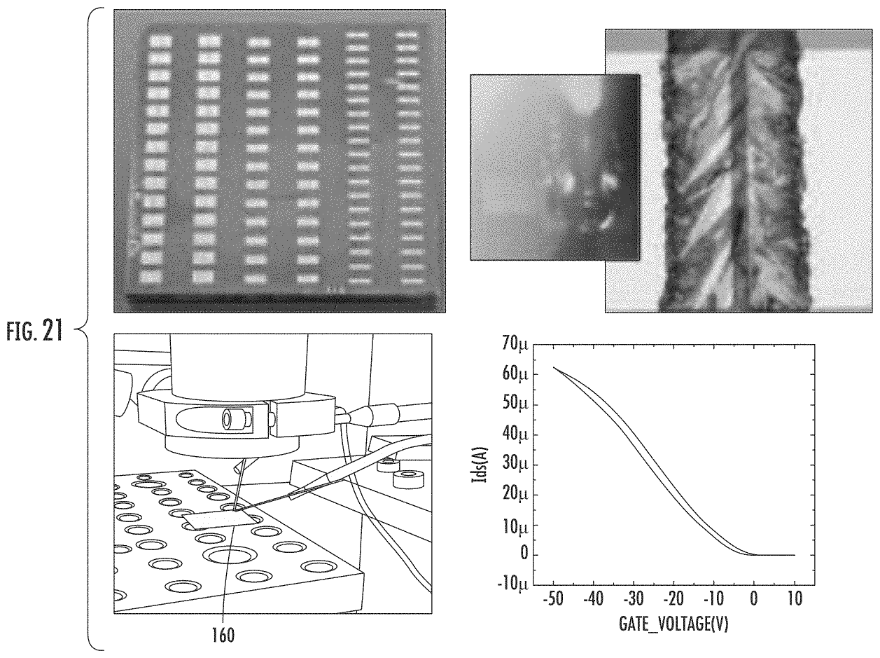

FIG. 21 is a series of images that show a demonstration of Si substrates pre-patterned with electrodes enabling electrical characterization (conductivity) as well as fabrication of two-terminal devices, such as photodetectors, and three-terminal devices, like field-effect transistors according to an embodiment of the presently disclosed subject matter. In the example, a small molecule organic semiconductor is formulated and printed on the pre-patterned substrate and the organic FET is subsequently tested using an automated probe station to extract OFET figures of merit.

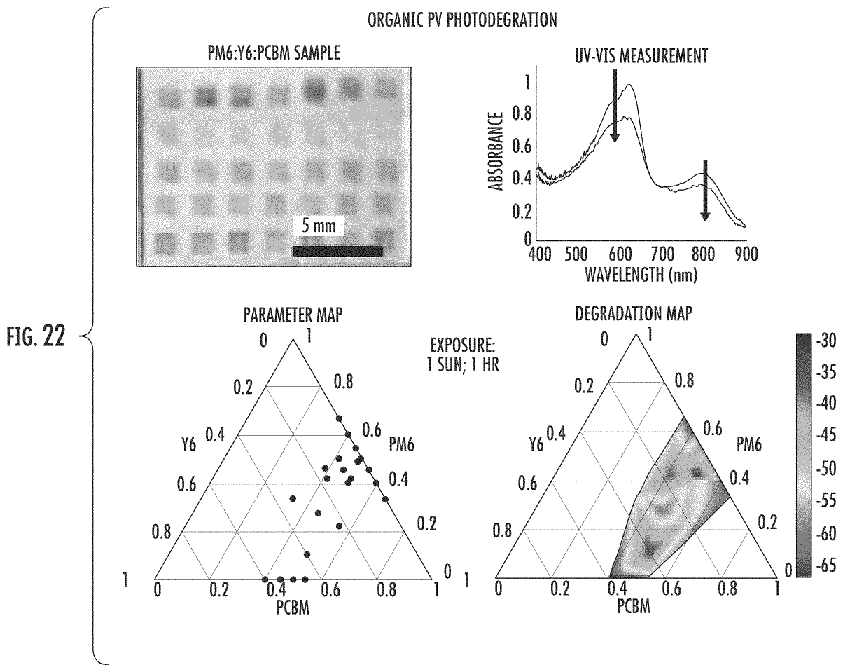

FIG. 22 is a series of diagrams that illustrate semiconducting polymer formulation and printing on glass substrates for a photodegradation study according to an embodiment of the presently disclosed subject matter. Ternary inks are prepared using the liquid handler from stock solutions of the donor polymer and two acceptors according to the ternary compositional map illustrated on the lower left. Each ink is printed in a square pattern to allow automated UV-Vis absorbance measurements to be performed on the substrate prior to photodegradation of the entire substrate under simulated sunlight. The measurements are repeated after exposure and a degradation map is generated on the ternary compositional map allowing to identify compositions which are more or less susceptible to degradation.

As noted above, conventional systems and methods are considerably slower, more costly, and large scale than micro-experimentation where formulation and printing or coating are integrated, material footprint is miniaturized, and several materials are integrated on substrates and combined with micro-characterization. Existing automated platforms also integrate very few characterization methods because they tend to use dedicated components, making them very expensive. In contrast, by enabling the integration of multiple materials on a common substrate 160, the present platform 100 enables many more techniques to be used in a high throughput manner. One benefit is that the characterization tools do not need to work as much to generate the same amount of data and do not need to be dedicated to the platform 100 by eliminating the need to load, align, and calibrate every sample being analyzed as in conventional automation. This significant time saving means that such instruments can be used part time when a sample with dozens or hundreds of materials is ready to be loaded, while being used for other research uses the rest of the time. This also means that existing research infrastructure can be used to perform high throughput experimentation on samples generated using micro-experimentation platforms without the need to purchase new characterization tools. Representative examples of characterization techniques that are enabled by having multiple materials on the substrate include optical and electron microscopy, Raman microscopy, laser-based photoluminescence spectroscopy, electrical characterization, stylus and optical profilometry, and microbeam x-ray diffraction, among others.

In some embodiments, a non-transitory computer readable medium comprising computer executable instructions embodied in a computer readable medium that when executed by a processor of a computer control the computer to perform steps for formulation of inks from feedstock and for depositing material samples on substrates, including operating a liquid handler to draw samples from a plurality of solution components and mix the components together to create a plurality of ink formulations, transferring the ink formulations to a common substrate to form material samples, and/or characterizing the material samples on the substrate. In some embodiments, the non-transitory computer readable medium comprising computer executable instructions embodied in a computer readable medium that when executed by a processor of a computer control the computer to perform any method steps as disclosed herein. Such method steps and indeed any steps, methods, processes, algorithms, and the like disclosed herein can be embodied by a module, which can be stored in memory and executed by a hardware processor.

Regardless of the particular configuration, the present systems and methods can provide a number of advantages. Automated micro-experimentation and substrate integration with micro-characterization has many implications: Cost of data is 50× less than manual experimentation and 5× less than automated serial experimentation with full scale samples. In addition, a significant commercial problem this solves is translation from lab to fab that many industries currently struggle with because of a mismatch between laboratory scale research coating techniques and manufacturing scale slot die coating and which is a common challenge with materials design, development and manufacturing. The end-to-end automated micro-experimentation using slot die coating helps address this challenge. This platform helps address the problem for solution-phase materials that are destined for coating and device applications.

Unless defined otherwise, all technical and scientific terms used herein have the same meaning as commonly understood to one having ordinary skill in the art to which the presently disclosed subject matter belongs. Although, any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims. Thus, for example, reference to “a vial” can include a plurality of such vials, and so forth.

Unless otherwise indicated, all numbers expressing quantities of length, diameter, width, and so forth used in the specification and claims are to be understood as being modified in all instances by the terms “about” or “approximately”. Accordingly, unless indicated to the contrary, the numerical parameters set forth in this specification and attached claims are approximations that can vary depending upon the desired properties sought to be obtained by the presently disclosed subject matter.

As used herein, the terms “about” and “approximately,” when referring to a value or to a length, width, diameter, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate for the disclosed apparatuses and devices.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub-combinations of A, B, C, and D.

The presently disclosed subject matter can be embodied in other forms without departure from the spirit and essential characteristics thereof. The embodiments described therefore are to be considered in all respects as illustrative and not restrictive. Although the presently disclosed subject matter has been described in terms of certain preferred embodiments, other embodiments that are apparent to those of ordinary skill in the art are also within the scope of the presently disclosed subject matter.

What is claimed is:

1. A system for the formulation of inks from feedstock comprising:
a liquid handler configured to draw samples from a plurality of solution components and mix the components together to create one or more ink formulations;
a dispensing robot configured to transfer the one or more ink formulations to a common substrate to form one or more material samples; and
a controller in communication with each of the liquid handler and the dispensing robot, the controller being configured to coordinate the creation and transfer of the one or more ink formulations.

2. The system of claim 1, wherein the liquid handler is configured to dispense each of the one or more ink formulations to a well of an array of sample wells.

3. The system of claim 1, wherein the liquid handler is configured to draw samples of approximately 50 microliters or smaller from the plurality of solution components.

4. The system of claim 1, wherein the liquid handler is configured to mix the components within the liquid handler to prepare the one or more ink formulations.

5. The system of claim 1, wherein the dispensing robot is configured to draw samples of approximately 1 nanoliter or smaller of each ink formulation prepared by the liquid handler.

6. The system of claim 1, wherein the dispensing robot is configured to transfer the one or more ink formulations to the common substrate in a pattern comprising one or more of a dot, a line, or a geometric shape.

7. The system of claim 1, wherein the dispensing robot is configured to transfer the one or more ink formulations at one or more pre-defined location, shape, size, separation, and/or repetition on the common substrate.

8. The system of claim 1, wherein the plurality of solution components comprises materials selected from the group consisting of semiconducting materials, semiconducting polymers, conducting polymers, insulating polymers, conjugated molecules and components thereof, metal halide perovskite components, hybrid metal halide components, nanoparticles, and colloidal quantum dot components.

9. The system of claim 1, comprising a first wash station configured to rinse an exterior of the liquid handler between the draw of samples of different ink formulations.

10. The system of claim 1, comprising a second wash station configured to wash an interior of the dispensing robot between the transfer of different ink formulations.

11. The system of claim 1, comprising one or more characterization instrument configured to characterize the material samples on the common substrate.

12. A system for the formulation of inks from feedstock comprising:
a liquid handler configured to draw samples from a plurality of solution components and mix the components together to create one or more ink formulations;
a coating element in communication with the liquid handler and configured to transfer the one or more ink formulations to a common substrate to form one or more material samples; and
a controller in communication with the liquid handler, the controller being configured to coordinate the creation and transfer of the one or more ink formulations.

13. The system of claim 12, wherein the coating element comprises one of a slot die head or a spray nozzle.

14. A method for the deposition of materials on a common substrate, the method comprising:
operating a liquid handler to draw samples from a plurality of solution components and mix the components together to create one or more ink formulations; and
transferring the one or more ink formulations to a common substrate to form one or more material samples;
wherein operating the liquid handler and transferring the one or more ink formulations are coordinated by a computer controller.

15. The method of claim 14, wherein operating the liquid handler comprises rinsing an exterior of the liquid handler between the draw of samples of different ink formulations.

16. The method of claim 14, wherein operating the liquid handler comprises dispensing each of the one or more ink formulations in a well of an array of sample wells.

17. The method of claim 14, wherein transferring the one or more ink formulations to a common substrate comprises transferring the one or more ink formulations to the common substrate in a pattern comprising one or more of a dot, a line, or a geometric shape.

18. The method of claim 14, wherein transferring the one or more ink formulations to a common substrate comprises transferring the one or more ink formulations at one or more pre-defined location, shape, size, separation, and/or repetition on the common substrate.

19. The method of claim 14, comprising:
loading the common substrate in a characterization instrument; and
characterizing the one or more material samples on the common substrate.

20. The method of claim 19, wherein characterizing the one or more material samples comprises applying one or more of an optical, a structural, or an electrical characterization technique.

21. The method of claim 19, wherein characterizing the one or more material samples comprises storing characterization data associated with the one or more material samples.

22. The method of claim 21, wherein storing characterization data comprises constructing a database from which data analytics and/or visualization of the characterization data are derivable.

23. The method of claim 21, wherein characterizing the one or more material samples comprises guiding one or more future experiments manually, automatically, semi-autonomously, or autonomously based on application of statistical, machine-learning, or artificial intelligence algorithms to the characterization data.
